(19) United States
(12) Patent Application Publication
(10) Pub. No.: US 2003/0153297 A1
(43) Pub. Date: Aug. 14, 2003

(54) Personal alert and rescue system (PARS)

(76) Inventors: Charles Leslie Falkiner, Norfolk, VA (US); Charles Ruffin Falkiner, Cary, NC (US)

Correspondence Address: Peter A Shaddock II, Kaufman & Canoles, 150 West Main Street, P O Box 3037, Norfolk, VA, 23514-3037, US

(21) Appl. No.: 10/073,384

(22) Filed: Feb. 12, 2002

(51) Int. Cl. H04B 7/00

(52) U.S. Cl. 455/404; 455/66

(57) ABSTRACT

This invention is a personal alert and rescue system for a golf course. It includes a communication link between a golfer and a clubhouse. The system includes an audio interlock feature that prevents unauthorized communications. At least two special function buttons are provided on a mobile transceiver unit. One special function button corresponds to a medical emergency; and the other corresponds to a mechanical emergency. A method for conducting emergency communications is also disclosed.

This application claims priority from a provisional patent application filed with the U.S. Patent and Trademark Office on Aug. 16, 2001.

The invention received no federal research and development funding.

### TECHNICAL FIELD

The invention relates to a communications device for use on a golf course. More particularly the invention relates to a communications link between golfers on a golf course and the clubhouse.

### BACKGROUND OF THE INVENTION

Most golf courses lack adequate communications between players on the course and the clubhouse. If a player desires to contact the clubhouse, on many courses he must use a cell phone to establish communications with the clubhouse. A few golf courses have landline telephones installed typically at mid-course. Some golf carts are equipped with global positioning system receivers that indicate the location of the golf cart on the course that incorporates communication facilities. However, this system is expensive and many courses cannot afford it. So when an emergency arises on a non-GPS equipped course, a player must proceed to the nearest cellular or landline telephone in order to alert the clubhouse of the emergency.

The lack of adequate communications between the clubhouse and the player is of significant concern when a life-threatening emergency arises. Minutes and even seconds become important when providing aid to a victim of serious illness such as a heart attack. If a communications interface cannot be quickly established between a player in need of medical assistance and the clubhouse, precious time is wasted. The ability of golf course staff to quickly respond to medical emergencies is nil if the staff cannot be contacted. First aid methods and devices such as portable defibrillators can increase the likelihood of survival of an individual suffering from a serious medical condition. However, the application of first aid or the use a portable defibrillator is ineffective if the staff cannot be informed of the medical emergency.

### SUMMARY OF THE INVENTION

The present invention is directed to a communication system that comprises a plurality of mobile transceivers and a fixed base unit. The mobile transceivers comprise a keypad, special function buttons, and switching circuitry for controlling audio input/output. The mobile transceivers are pre-programmed to transmit information indicative of a golfer's location and a type of emergency to the fixed base station. After receiving and decoding a signal indicating the emergency and location, the base station then displays this information and enables an audio interface between the base station and the mobile transceiver that transmitted the emergency signal. An audio interlock prevents casual use of the transceiver.

One purpose of the invention is to provide a communications interface that is simple and economical. In one embodiment of the invention, a system is provided which utilizes off-the-shelf or existing radio systems such as handheld transceivers. The transceivers are used to quickly and easily transmit the location and type of assistance needed to the appropriate golf course staff. The transceivers are pre-programmed to transmit a course number if the player is on one of a number of courses at the golf facility. The golfer enters the fairway number on a keypad and/or specialized buttons or display screen. The specialized buttons or display screen comprises a button or area of the display screen designated for at least medical emergencies and mechanical breakdowns. Other buttons for selecting various types of assistance may also be included in the system.

Additional embodiments include a bio-monitor located on a golfers body or clothing which monitors vital human functions. The mobile units may be equipped with various other functionality switches. Further, the mobile units may automatically recognize the location of the golf cart on the fairway.

Since the system is equipped with an audio interlocking interface, communications between a golfer in need of assistance and the clubhouse is secure. Therefore, other golfers are not interrupted during play by the transmission of a golfer in need of assistance.

In another embodiment, the transceivers may be equipped with a receive-all function. The receive-all function allows the clubhouse to send messages to all of the golfers at once. For example, an emergency message that alerts all the golfers of an approaching thunderstorm may be transmitted from the clubhouse thereby allowing the golfers to seek shelter prior to the arrival of dangerous weather conditions such as lighting. In fact the transceivers may be equipped with circuitry that monitors the National Weather Service. Thus, when an emergency message is broadcast, the transceivers will automatically broadcast the message to the golfers. Alternatively, this monitoring feature may be incorporated into the base station and transmitted to the golfers via the receive-all function.

The PARS comprises at least one remote transceiver that transmits information including at least the location and type of assistance needed by a golfer and a base system including a transceiver that receives information from the one remote transceiver. The PARS comprises a mobile transceiver means for transmitting at least a golfer's location and type of emergency. The mobile transceiver also includes means for recognizing an audio enable signal and for receiving transmitted instructions from a fixed transceiver. The PARS also comprises a fixed transceiver means for receiving a signal indicative of a golfer's location and type of emergency. The fixed transceiver means may include a display device for displaying the golfer's location and type of emergency. The fixed transceiver means is equipped with an audio enabling signal generating circuit. The audio enabling signal generating circuit produces a coded signal that acts as an electronic key. When the coded signal is received and decoded by the remote transceiver, an audio interlock is unlocked thereby allowing the golfer using the remote transceiver to establish audio communications with the user of the fixed transceiver.

In another embodiment the remote transceiver unit comprises an audio interface that includes a microphone and a speaker for establishing audio communications with the clubhouse. The remote transceiver also comprises an antenna for receiving electronic signals and an audio interlock for preventing unauthorized communications. A micro-controller stores code that comprises a software program. The micro-controller also controls the transceiver. Special function buttons and a keypad are also included in the remote transceiver unit for entering information such as the course or fairway number along with the type of emergency assistance sought. A battery or other type of power supply is included in the remote transceiver unit for providing power. A display may be coupled to the unit for displaying information such as first aid instructions or troubleshooting techniques for mechanical emergencies.

In a further embodiment the fixed transceiver or base station includes an audio interface that comprises a microphone and a speaker for establishing audio communications with a remote transceiver. The base station further comprises a micro-controller for decoding information and displaying information on a display means. The micro-controller receives commands from special function buttons and a keypad. A power supply provides power to the base unit. A display is coupled to the micro-controller for exhibiting information such as the type of emergency a player is experiencing and the player's location.

In another embodiment of the invention, the remote transceiver is incorporated into a retrofit kit that may quickly be disassembled to charge batteries powering the transceiver unit. A retrofit kit is a device that accepts readily available off-the-shelf hardware to configure the remote transceiver. The retrofit kit includes connections for connecting with an existing off-the-shelf transceiver. The ability to quickly disassemble the retrofit kit greatly enhances the value of this product. If a system failure occurs in the retrofit kit, the off-the-shelf transceiver may summarily be removed from the retrofit kit and used as a communications link between the golfer and the clubhouse. Thus, the off-the-shelf transceiver may be used as a stand-alone unit for communicating with the clubhouse. It should therefore be realized that audio communications between the clubhouse and an existing transceiver might be conducted without need for an audio interlocking system. Thus, if a failure occurs in the retrofit kit and not in the transceiver, then the system includes a redundancy method for establishing a communications link between a golfer in need of assistance and the clubhouse.

The base unit includes a program for controlling the microprocessor. The program comprises a routine that continuously monitors a receiver unit in the base unit for a coded signal. If no coded signal is received, the program is continuously looped to monitor the receiver unit. Upon receipt of a coded signal, the program prompts a display means to display information comprised of at least a golfer's location and type of emergency assistance needed. The information may include the nearest fairway number on the appropriate course, as well as, whether the emergency is mechanical failure or physical ailment in nature. An audible alarm sequence for alerting a base station operator of the existence of an emergency may also be triggered by the program. The operator of the base station may then push a button that causes an audio enabling signal to be sent to the remote transceiver unit thereby enabling audio communications between the base station and the remote unit. After the emergency has been appropriately dealt with, the base station operator may reset the system by pushing a reset button. The emergency will be removed from the display and a reset code may be transmitted to the remote unit to cause it to be reset.

The remote unit includes a program that continuously monitors the state of at least one special function button or touch screen. When a golfer strikes the special function button, the program cues the golfer to enter a fairway number. In some systems the fairway number will be automatically recognized and the step of entering the golfer's location will be unnecessary. In one embodiment of the invention, the audio may be unlocked when the special function button is struck. In another embodiment, the audio will not be unlocked until a coded signal is sent from the base station.

This invention includes a process for monitoring and alerting a clubhouse of an emergency comprised of transmitting a signal from a golfer in need of assistance. The signal includes at least the location of the golfer and the type of emergency. By transmitting the type of emergency, the operator of the base station can assess multiple emergencies and advantageously prioritize several emergencies at once. This process further includes a method of interlocking audio communications, so that a communication net comprised of the base station and several remote units will not be used for unauthorized communications. The process further comprises establishing an audio communications link between the golfer in need of assistance and the clubhouse.

In one embodiment the invention includes a method for alerting a fixed transceiver of an emergency. The method comprises: transmitting a coded signal from a remote transceiver whereby the coded signal comprises at least the location of a golfer and a type of emergency; receiving the coded signal in a fixed transceiver and alerting an operator of the fixed transceiver to the emergency; transmitting, from the fixed receiver, a code comprised of information that unlocks an audio interlock in the remote transceiver; and establishing an audio interface between the remote transceiver and the fixed transceiver. This method may further comprise the use of touch screens or special function buttons to transmit different coded signals relating to various emergency situations. The method may also include resetting the audio interlock by transmitting a coded signal from the fixed transceiver to the remote transceiver.

A further process for implementing the invention comprises transmitting information concerning an emergency condition and location of a golfer from a mobile transceiver to a re-transmission platform; relaying the transmitted information to a fixed transceiver; transmitting a signal that unlocks an audio interface from the fixed transceiver to the re-transmission platform and relaying the signal that unlocks the audio interface to the mobile transceiver. Once the audio interface on the mobile transceiver has been unlocked, an audio communication link between the mobile transceiver and the fixed transceiver can be established. If necessary, the audio communication link may include use of the re-transmission platform to relay information between the mobile and fixed transceivers.

The invention may also comprise audible and visual alarm devices affixed to the golf cart. Typically, the alarm devices are activated when the special function button is depressed. Alternatively, they may be activated when the audio interlock is disengaged.

The following is a typical sequence of events describing how an emergency may be handled with the invention.

A medical emergency occurs on the fourth fairway. The player experiencing the emergency or a member of his party presses button “4”, then the medical alert button on the keypad indicating that a medical emergency has occurred on the fourth fairway.

A coded signal is sent from the mobile transceiver unit to the base station transceiver. If the golf cart is equipped with an emergency flashing light and audible alarm, they are activated. Typically, the light is a red beacon attached to the top of the golf cart.

The base station receives the coded signal, and emits an audio signal heard on the loudspeaker of the handheld. Simultaneously, the audio signal is decoded by the microprocessor included in the fixed base unit. An audible signal is emitted from the speaker of the fixed base unit. A message is displayed on the display unit of the fixed base unit. For example, a flashing “4” may be displayed on the display together with the word such as “Medical” to indicate a medical emergency on the fourth fairway. Other visual and aural alerts may sound in designated clubhouse areas.

A first aid team is dispatched to the fourth fairway via the fastest means of transport. The base station operator presses transmit on the unit causing an electronic key to be transmitted. The electronic key when received by the mobile transceiver unit unlocks an audio interlock at the mobile unit, switches off the audible alarm, and allows enquires as to nature of medical emergency.

A reply from the golf cart is heard by both the base station operator and a medical team who are monitoring the communications link between the golfer in need of medical assistance and the clubhouse. The base station operator alerts 911, if necessary.

Upon reaching the fourth fairway and the scene of emergency, the medical team commences treatment and advises the base station operator as to additional action required. At this point, the red beacon or audible alarm on the golf cart is turned off.

Once the golfer has been treated and moved, the base station operator is advised and resets the system for that particular golf cart.

Further objects, features and advantages of the invention will become apparent from a consideration of the following description and the included claims when taken in connection with the previous discussion and the accompanying drawings. It should be appreciated that all software programs discussed in this patent application may be implemented by using modern engineering practices and electronic circuitry. The scope of this patent and the accompanying claims should be recognized as having hardware implementation that is equivalent to the software programs.

### BRIEF DESCRIPTION OF THE DRAWING

FIG. 1 is a block diagram of a remote transceiver.

FIG. 2 is a block diagram of a base station.

FIG. 3 is a flowchart of software for the base station.

FIG. 4 is a flowchart of software for the remote transceiver unit.

FIG. 5 is a typical mobile keypad/transceiver layout sketch

### DETAILED DESCRIPTION OF THE INVENTION

The following is the preferred embodiment or best mode for carrying out the invention. It should be noted that this invention is not limited by the discussion of the preferred embodiment.

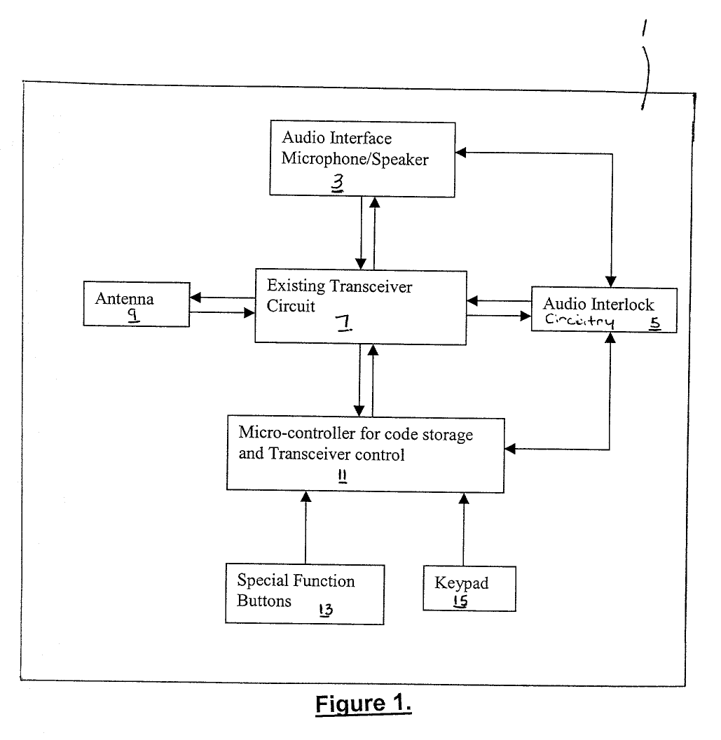

FIG. 1 depicts a remote unit 1 comprised of an existing transceiver circuit 7. The remote unit includes an audio interface comprised of a microphone and speaker. Microphone control circuitry is typical for existing transceivers and is not shown in the figure. Audio interlock circuitry 5 prevents a golfer from using the transceiver 7 to casually communicate with others. The audio interlock circuitry 5 controls the transmission ability of the remote unit 1 and enables the audio interface when the appropriate signal is received from the clubhouse. It should be noted that in this embodiment, the audio interlocking circuitry is shown as a separate component. However, the audio interlock may be implemented as a program in the micro-controller. If an enable signal is not sent from the clubhouse, then the golfer cannot conduct voice communications with anybody, so long as the transceiver 7 remains in the remote unit 1.

An antenna 9 is connected to the transceiver 7 for receiving and transmitting radio frequency signals. A micro-controller 11 with a software program continuously monitors the position of special function buttons 13. The special function buttons 13 correspond to various types of emergencies. As previously mentioned, the special function buttons 13 may be implemented through touch-screen technology.

The micro-controller 11 instantly recognizes when an operator depresses a special function button 13. After recognizing that a special function button has been depressed 13, the micro-controller 17 enables the transmitter (not shown) of the transceiver and causes a coded signal corresponding to the type of emergency to be transmitted to the clubhouse. The micro-controller 11 then monitors the receiver portion (not shown) of the transceiver for an audio interlock-enabling signal.

If an audio interlock-enabling signal is not received after a predetermined period, the micro-controller automatically retransmits the coded signal indicating that an emergency has occurred. After a predetermined number of unanswered transmissions, the micro-controller 11 alerts the operator of a system failure. At this point, the operator may remove the transceiver 7 from the remote transceiver unit 1 and try to establish a direct audio communications link with the clubhouse. A keypad 15 is electrically connected to the micro-controller for use in entering information such as the fairway number.

If the coded signal is successfully received by the transceiver 19 located in the clubhouse, the operator in the clubhouse will transmit a second coded signal to the transceiver 7 in the remote unit 1. The second coded signal transmitted includes a key for unlocking the audio interlock. Once the second coded signal is received and decoded by the micro-controller 11 in the remote unit 1, it unlocks the audio interlock and switches off the audible alarm, thereby promptly enabling an audio communications link to be established between the remote unit 1 and the fixed base unit 31. The golfer in need of assistance may then appropriately relay information back to the clubhouse. If a medical emergency exists, the clubhouse can alert the appropriate medical authorities of the condition and relay any lifesaving information to the golfer. If the emergency is a mechanical one, such as operational failure of a golf cart, the clubhouse can send a mechanic along with a substitute golf cart so that the golfer may continue playing his round of golf.

A power source is necessary for operating the remote unit 1 but not shown in the drawing. The power source may be comprised of an independent battery source or may include power connections to the battery supplying the golf cart. Other alternative sources of power may include solar cells mounted in an appropriate arrangement on a golf cart. It should also be noted that the existing transceiver circuit might include an additional microphone and speaker not shown in the figures.

The housing or retrofit kit of the remote unit 1 is constructed in a manner such that a golfer can easily operate the keypad 15 and special function buttons 13. The micro-controller 11 controls the routing of signals via switches so that signals to be transmitted are sent to the transmitter and received signals are decoded and interpreted as commands or sent to the speaker. The transmitted coded signals are typically transmitted by a tone pulse width method commonly used in remote control systems. Various other types of known coding of signals may be used for implementing this invention.

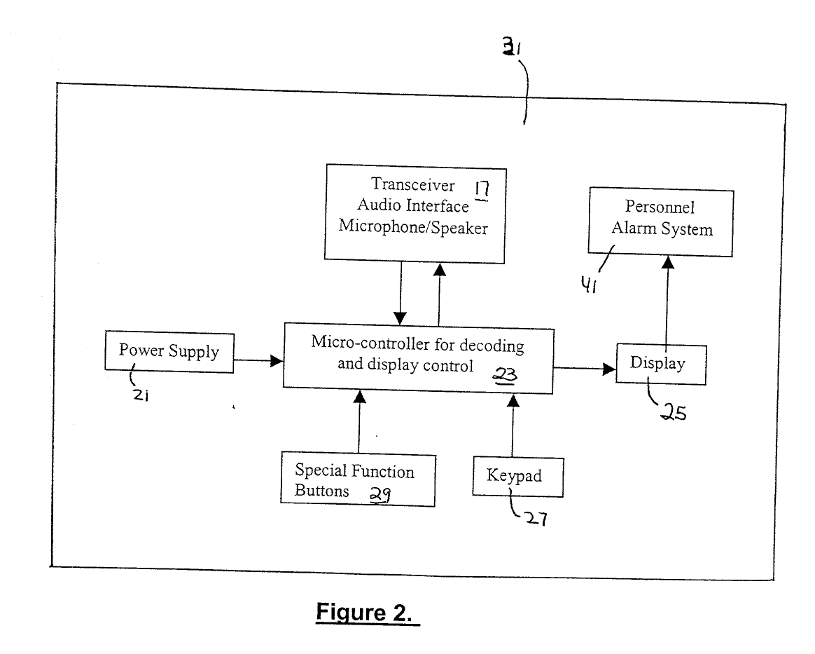

FIG. 2 is a block diagram of the base station 31. The transceiver audio interface 17 comprising the microphone and speaker shown in FIG. 2 perform similar functions as those mentioned above with respect to FIG. 1. The microcontroller 23 includes a program for receiving coded messages and converting them to be displayed on a display screen 25. The micro-controller 23 may include a list of options for responding to different types of emergencies. These options may be listed on the display 25 when the operator is alerted to the emergency. A personnel alarm system 41 is linked to the display 25 for providing other alarms to alert personnel of the emergency. The personnel alarm system 41 may be linked to the micro-controller 23 or transceiver 17. For example, if a golfer transmits a signal indicative of a life-threatening emergency, the screen may provide the telephone numbers of the local ambulance service and hospital. It may also include first aid information that may be automatically relayed to the golfer or relayed via the operator.

A power supply 21 for converting alternating current to direct current is provided in the base station 31. Special function buttons 29, such as a system reset, is included in the base station 31. A keypad 27 for input and program control may also be included in the base station 31. Alternatively, the display 25 may comprise touch screen technology for input and program control. Typically, the base station 31 consists of the above-mentioned parts contained in a housing.

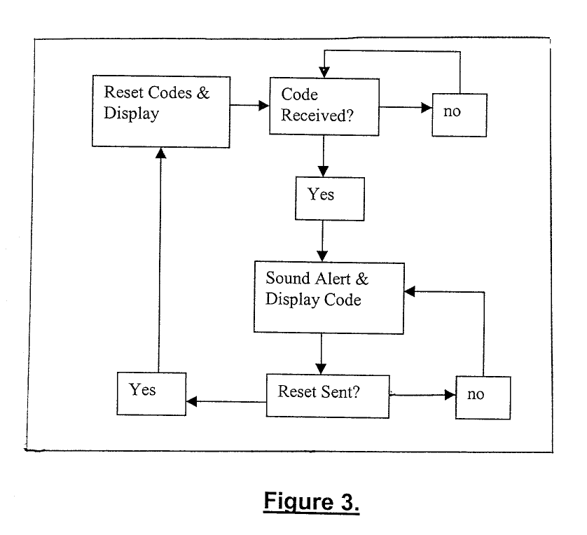

FIG. 3 depicts a software flowchart for the base station 31. The microcontroller 23 continuously monitors the input from the receiver to see whether a coded signal has been received from the transmitter of a remote transceiver unit 1. If a coded signal is received, the micro-controller 23 decodes the signal and sounds an alert. Simultaneously, the type of emergency is displayed on the display 25 of the fixed base station 31.

An operator of the base station 31 then transmits an audio enable signal to the remote transceiver unit 1. Instructions for handling the emergency may also be transmitted at this time. Alternatively, the operator may question the golfer for more details about the type of emergency. The display screen 25 may show emergency numbers and suggest courses of actions for handling the emergency. The base station 31 may be equipped with a dial-up feature that automatically dials emergency numbers and relays information to the appropriate authorities. An audio communications link between the base station 31 and the remote transceiver unit 1 is maintained during the entire emergency condition unless another emergency situation arises from another golfer. After the emergency situation has been resolved, the operator of the base station resets the base station 31 and sends a reset signal to the remote transceiver unit 1 that transmitted the emergency.

If a second emergency situation arises during the first emergency, the base station 31 prioritizes the emergencies according to the seriousness of each situation. Each remote transceiver unit 1 is reset after each emergency is resolved. This same protocol is followed for multiple emergencies.

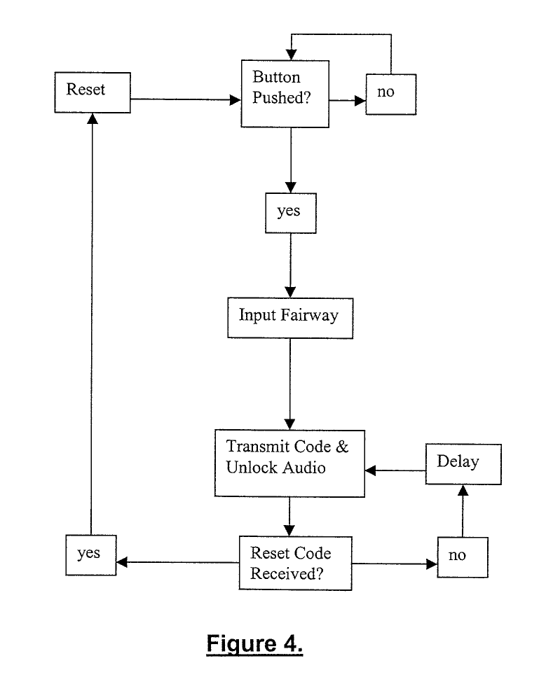

FIG. 4 depicts a software flowchart for the remote transceiver unit 1. The micro-controller 11 continuously monitors the special function buttons 13 if the unit is equipped with them. If the unit is equipped with a touch screen, the micro-controller 11 will monitor the appropriate sections of the screen. When a special function button 13 is depressed, the golfer is cued by the micro-controller 11 to input the fairway number. After the fairway number is input via the keypad, 15 a coded message comprised of information indicating the type of emergency and the location of the golfer, is transmitted to the base station 31. The remote transceiver unit 1 receives a coded message comprising an unlock code from the base station 31. Once the unlock code has been decoded in the micro-controller 11 unit of the remote transceiver unit 1, audio communications are established between the base station 31 and the remote controller unit 1. In an alternative embodiment, the remote transceiver unit 1 automatically unlocks the audio interlock circuitry after a special function button 13 has been depressed. The remote transceiver unit 1 resets the audio interlock when a coded signal is sent from the base station 31.

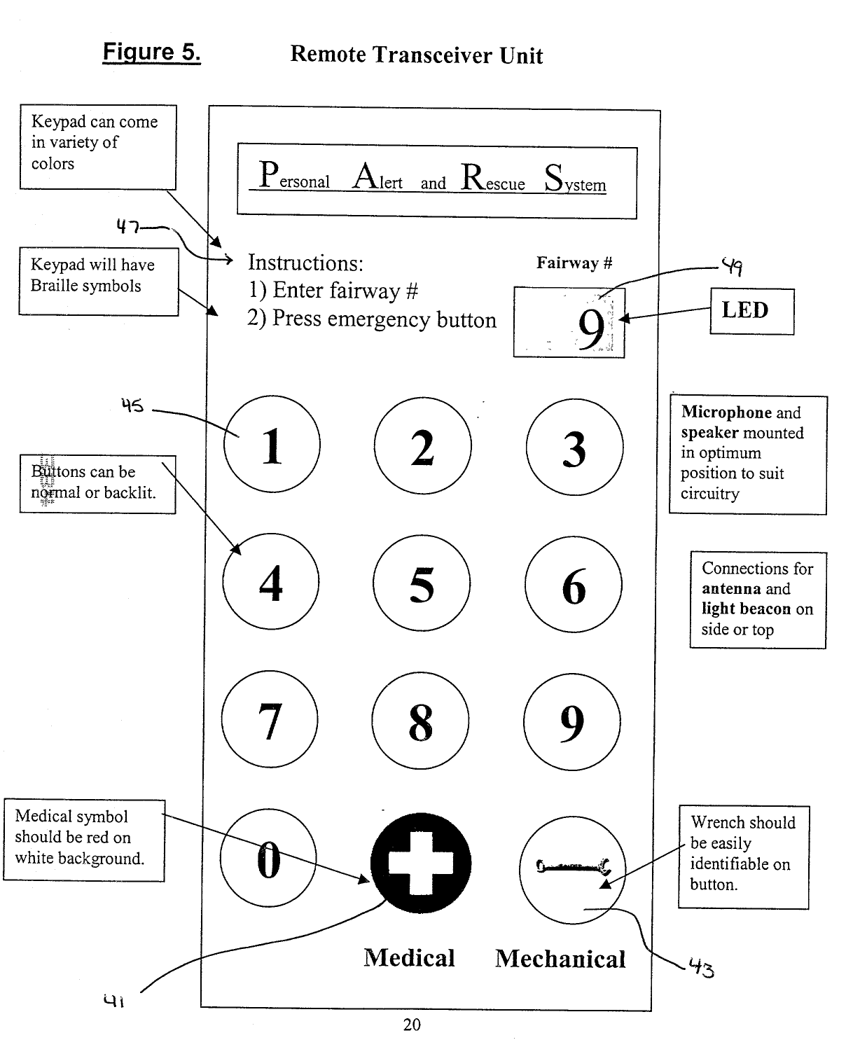

FIG. 5 depicts a layout for a typical remote transceiver unit. Use instructions 47 are provided on the remote transceiver unit 1. An light emitting diode (LED) or liquid crystal display (LCD) are provided for indicating the fairway number may also be provided on the remote transceiver unit 1. Buttons 45 are provided for inputting information such as the fairway number on which the players are golfing. Button 41 is a special function button for alerting the clubhouse that a medical emergency has occurred. Button 43 is a special function button for alerting the clubhouse when a mechanical failure has occurred. Other special function buttons may be provided on the remote transceiver unit 1 for performing other alert or non-alert functions.

It is to be understood that the invention is not limited to the exact construction illustrated and described above. Various changes and modifications may be made without departing from the spirit and the scope of the invention as defined in the following claims.

We claim:

1. A communication system comprising:
a plurality of mobile transceiver units; and
a fixed base unit,
wherein said mobile transceiver units comprise a keypad, at least one special function button and switching circuitry for controlling audio input and output.

2. The communication system of claim 1 wherein said mobile transceiver units are pre-programmed to transmit information indicative of a golfer's location on a fairway and a type of emergency.

3. The communication system of claim 1 wherein said fixed base unit comprises a display device for displaying information relating to the emergency.

4. The communication system of claim 1 wherein said fixed base unit further comprises a means for controlling voice communications transmitted from said mobile transceivers.

5. The communication system of claim 4 wherein said mobile transceiver units further comprise an audio interlock circuit for preventing casual use.

6. The communication system of claim 1 wherein said mobile transceiver units are hand-held transceivers.

7. The communication system of claim 1 wherein said mobile transceiver units include a circuit for transmitting a coded signal indicative of the location of the transceivers and type of assistance desired.

8. The communication system of claim 1 wherein said mobile transceiver units include a keypad or touch screen for entering at least the fairway number and type of assistance desired.

9. The communication system of claim 1 wherein said system further comprises a bio-monitor for monitoring physiological data of a golfer.

10. The communication system of claim 1 wherein said mobile transceiver units include a means for automatically recognizing the location of the mobile transceiver units on the fairway.

11. The communication system of claim 1 wherein said fixed base unit includes a receive-all function for transmitting a message to all mobile transceiver units simultaneously.

12. The communication system of claim 1 wherein said mobile transceiver units includes means for recognizing an audio enable signal.

13. The communication system of claim 1 wherein said fixed base unit includes means for displaying a golfer's location and type of emergency.

14. The communication system of claim 1 wherein said fixed base unit includes an audio enabling signal generating circuit.

15. The communication system of claim 14 wherein said audio enabling signal generating circuit includes means for producing an electronic key for enabling voice communications between said fixed base unit and at least one of said mobile transceiver units.

16. The communication system of claim 1 wherein said mobile transceiver units comprise an audio interface that includes a microphone and a speaker for establishing audio communications with a clubhouse.

17. The communication system of claim 1 wherein said mobile transceiver units include a micro-controller for storing a software program.

18. The communication system of claim 1 wherein said mobile transceiver units include a display unit for displaying information such as first aid instructions.

19. The communication system of claim 1 wherein said fixed base unit includes a microphone and a speaker for establishing audio communications.

20. The communication system of claim 1 wherein said fixed base unit further comprises a micro-controller for receiving and decoding commands from at least one special function button located one of said mobile transceiver units.

21. The communication system of claim 1 wherein at least one of said mobile transceiver units further comprises a transceiver that may be readily removed from the one of said mobile transceiver units.

22. The communication system of claim 1 wherein said mobile transceiver units comprise a special function button operationally connected to an audio interlock that unlocks an audio circuit to establish a communications link between the mobile transceiver units and the fixed base unit.

23. The communication system of claim 1 further comprising an alarm means for either emitting an audible alarm or displaying a visual alarm.

24. A personal alert and rescue method comprising:
recognizing an emergency;
actuating a special function button to transmit a signal to a distant location, said signal being indicative of a nature of the emergency;
transmitting a signal from said distant location that disables an audio interlock; and
establishing audio communications between two transceivers.

25. The method of claim 24 further comprising:
dispatching personnel to the location of said emergency.

26. The method of claim 24 further comprising:
transmitting instructions for handling the emergency.

27. A personal alert and rescue system comprising:
a plurality of mobile communication means for reporting emergencies; and
a fixed communication means,
wherein said each of said mobile communication means comprise a keypad, at least one special function button and switching circuitry for controlling audio input and output.
